(19) United States
(12) Patent Application Publication
(10) Pub. No.: US 2026/0310642 A1
(43) Pub. Date: Oct. 8, 2026

(54) SYSTEM AND METHOD FOR UPGRADING OBJECTS

(71) Applicant: DevRev, Inc., Palo Alto, CA (US)

(72) Inventors: Akash Revankar, Bangalore (IN); Jan Olderdissen, Herrenberg (DE); Shivansh Rai, Bangalore (IN); Brian Byrne, Issaquah, WA (US)

(73) Assignee: DevRev, Inc., Palo Alto, CA (US)

(21) Appl. No.: 19/171,136

(22) Filed: Apr. 4, 2025

(51) Int. Cl. G06F 16/215; G06F 16/23; G06F 16/2455

(52) U.S. Cl. CPC G06F 16/215; G06F 16/23; G06F 16/2456

(57) ABSTRACT

A method and system for upgrading objects is provided. The approach comprises creating one or more fragments using an application programming interface (API); wherein each fragment comprises a fragment identifier and one or more fields. The approach further comprises generating an object by referencing the one or more fragments and storing a value associated with each field. During operations, the approach comprises upgrading the object upon encountering modified fragments wherein upgrading comprises updating the object from the first fragment to the latest. Further the approach comprises memorizing the upgrade instructions in a upgrade database.

### CROSS-REFERENCE TO RELATED APPLICATIONS

This application is related to U.S. patent application Ser. No. 18/465,140, filed on Sep. 11, 2023, titled “CUSTOMIZED OBJECTS DEFINED BY MULTIPLE SCHEMA FRAGMENTS”, which is incorporated herein by reference in its entirety.

### BACKGROUND

The invention generally relates to the field of computing and more particularly, to a system and method for upgrading objects.

Modern computer systems use structured data representations to ensure interoperability, data integrity, and efficient processing. Schema fragments define the structure, constraints, and relationships of data objects across various platforms, including databases, application programming interfaces (APIs), and object-oriented programming frameworks. Objects representing instances of structured data, conform to these s to maintain consistency across different systems.

As software systems evolve, object structures require updates to support new features, and performance improvements. However, a significant challenge in evolution is the management of schema fragments. Fragments are discrete, reusable portions that define subsets of an overall data structure.

Schema fragments enhance modularity, maintainability, and scalability by enabling reusable components across systems. They reduce redundancy, ensure consistency, and simplify updates while maintaining backward and forward compatibility. In distributed architectures, fragments allow independent updates, supporting scalability without breaking services. They also ensure cross-platform integration and enforce data integrity, preventing inconsistencies.

However, upgrading objects with fragments is challenging due to dependency issues, where changes can break referencing objects. For example, objects not upgraded and synchronised with the latest fragments can lead to mismatched data, while performance overhead from migrations may cause downtime. Managing multiple versions adds complexity, and data integrity risks can lead to missing fields or corruption.

In addition, the number of fragment versions is a monotonically increasing number. Consequently, the amount of computation involved in upgrading an object increases with the increase in the number of fragment versions. It may be noted that a fragment cannot be upgraded to the latest version without reading intermediate versions of the fragments which makes computation tedious and increases resources

Therefore, there is a need for upgrading objects efficiently by effectively reading multiple fragments using minimum resources.

### SUMMARY

The following summary is illustrative only and is not intended to be in any way limiting. In addition to the illustrative aspects, example embodiments, and features described, further aspects, example embodiments, and features will become apparent by reference to the drawings and the following detailed description.

Briefly, according to an example embodiment, a computer implemented method for upgrading objects is provided. The method comprises creating one or more fragments using an application programming interface (API); wherein each fragment comprises a fragment identifier and one or more fields. The method further comprises generating an object by referencing the one or more fragments and storing a value associated with each field. During operations, the method comprises upgrading the object upon encountering modified fragments wherein upgrading comprises updating the object from one fragment to a latest fragment. Further the method comprises memorizing the upgrade instructions in a upgrade database.

In another embodiment, a computer processing system comprises a processing unit; a communications interface; and a non-transitory computer-readable storage medium to store instructions, is provided. The processing unit is configured to execute the stored instructions to create one or more fragments using an application programming interface (API); wherein each fragment comprises a fragment identifier, one or more fields, a forward reference field and a backward reference field. The processing unit is further configured to generate an object by referencing the one or more fragments and storing a value associated with each field. During operations, the processing unit is further configured to upgrade the object upon encountering modified fragments; wherein upgrading comprises updating the object one fragment to a latest fragment and memorize the upgrade instructions in an upgrade database.

In an alternate embodiment, a computer-readable medium comprising computer executable instructions that when executed by a processor of a computer, allows the processor to perform a method is provided. The method comprises creating one or more fragments using an application programming interface (API); wherein each fragment comprises a fragment identifier, one or more fields; a forward reference field and a backward reference field. The method further comprises generating an object by referencing the one or more fragments and storing a value associated with each field. During operations, the method further comprises upgrading the object upon encountering modified fragments; wherein upgrading comprises updating the object one fragment to a latest fragment and memorizing the upgrade instructions in a upgrade database.

### BRIEF DESCRIPTION OF THE FIGURES

These and other features, aspects, and advantages of the example embodiments will become better understood when the following detailed description is read with reference to the accompanying drawings in which like characters represent like parts throughout the drawings, wherein:

FIG. 1 is a schematic illustrating the relationship between an object and a fragment, implemented according to aspects of the present technique;

FIG. 2 is a flow chart describing one method to upgrade objects according to aspects of the present technique;

FIG. 3 is a flow chart illustrating an operation to read fragments and upgrade instructions implemented according to aspects of the present technique; and

FIG. 4 is a block diagram of an embodiment of a computing device in which the modules of the customer support system described herein are implemented.

### DETAILED DESCRIPTION OF EXAMPLE EMBODIMENTS

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein. On the contrary, example embodiments are to cover all modifications, equivalents, and alternatives thereof.

The drawings are to be regarded as being tic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Before discussing example embodiments in more detail, it is noted that some example embodiments are described as processes or methods depicted as flowcharts. Although the flowcharts describe the operations as sequential processes, many of the operations may be performed in parallel, concurrently, or simultaneously. In addition, the order of operations may be re-arranged. The processes may be terminated when their operations are completed but may also have additional steps not included in the figures. It should also be noted that in some alternative implementations, the functions/acts/steps noted may occur out of the order noted in the figures. For example, two figures shown in succession may, in fact, be executed substantially concurrently or may sometimes be executed in the reverse order, depending upon the functionality/acts involved.

Spatial and functional relationships between elements (for example, between modules) are described using various terms, including “connected,” “engaged,” “interfaced,” and “coupled.” Unless explicitly described as being “direct,” when a relationship between first and second elements is described in the description below, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular example embodiments only and is not intended to be limiting. Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless specifically stated otherwise, or as is apparent from the description, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

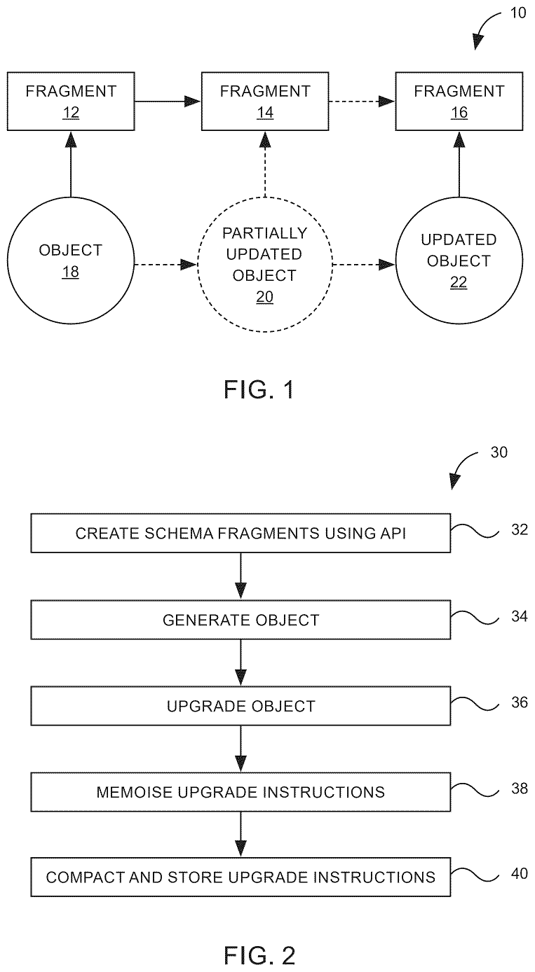

Example embodiments of the present invention provide a computer implemented system and method for upgrading objects. FIG. 1 is a schematic illustrating the relationship between an object and a fragment, implemented according to aspects of the present technique. As used herein, fragment and schema fragment are used interchangeably for the purpose of this description. The relationship of the object and the fragment is described in further detail below.

Fragment 12 is an entity used to define the schema of fields. In one embodiment, the fragment 12 has information such as field names, types and default values. Fragment 14 is a modified version of fragment 12 and similarly fragment 16 is a modified version of fragment 14. Fragment 14, 16 and 18 together form a fragment chain. The fragment chain captures the various version of the fragment. In one embodiment, each fragment includes a forward reference field and a backward reference field.

Object 18 is an instantiation of multiple fragment combinations. In this embodiment, object 18 reference fragment 12 and store values of the fields defined in each fragment. In one embodiment, fields in a collection of fragments do not overlap. Object 18 is partially upgraded to object 20 by reading fragment 14. Similarly, object 20 is further upgraded to object 22 by reading fragment 16. As used herein object upgrades refers to upgrading the version of a fragment an object is referencing to the latest version in the corresponding chain. In this example the latest version in the fragment chain is fragment 16. The manner in which the object is upgraded is described in further detail below.

FIG. 2 is a flow chart 30 describing one method to upgrade objects according to aspects of the present technique. It may be noted that an object may reference multiple fragments. It may also be noted that a single fragment may be referenced by multiple objects. Each step of the process is described in further detail below.

At step 32, one or more fragments are created by a user. In one embodiment, an application programming interface (API) is used to create fragments. Each fragment comprises a fragment identifier and one or more fields. In one embodiment, the fragment identifier is a number. Further, fragment comprises a forward reference field and a backward reference field. An example fragment is described below:
{
“id”: “fragment/1”, “fields”: [
   {
   “name”: “title”,
   “type”: “string”,
   “required”: true
   }
],
“forward_ref”: “fragment/2”,
“backward_ref”: null }
   In the above example, fragment/1 is the fragment identifier and the fields are name and type. The fragment 1 forward references fragment 2 and does not have a backward reference.

At step 34, an object is generated by referencing the one or more fragments. For the above example fragment, the object generated is shown below:
{
“id”: “book/1”,
“fragments”: [“fragment/1”],
“title”: “Upgrade Optimization”
}

At step 36, the object is upgraded during operation, upon encountering modified fragments referenced by the object. In one embodiment, the operations include read operations and/or write operations. It may be noted that upgrading an object includes updating the object from one fragment to a latest fragment.

Continuing with the example above, assume a second fragment as shown below:
{
“id”: “fragment/2”,
“fields”: [
{
   “name”: “title”,
   “type”: “string”,
   “required”: true
},
{
   “name”: “rating”,
   “type”: “int”,
   “default_value”: 5
}
],
“forward_ref”: null,
“backward_ref”: “fragment/1
}

In the above example fragment 1 references fragment 2 and therefore the object is updated using instructions in fragment 2. The updated object is shown below:
{
“id”: “book/1”,
“fragments”: [“fragment/2”],
“title”: “Upgrade Optimization”,
“rating”: 5
}

At step 38, the upgrade instructions corresponding to the upgraded objects are memoised. For the example above, the upgrade instructions are shown below:
{
   “source_fragment”: “fragment/1”,
   “target_fragment”: “fragment/2”,
   “instructions”: [
      {
         “field_name”: “rating”,
         “instruction_type”: “SET”,
         “value”: 5,
      }]}

At step 40, the upgrade instructions are compacted and stored in an upgrade database. In one embodiment, the upgrade instructions stored in the database is re-used when upgrading an object from the source fragment to the target fragment at a future instant. Thus, memorizing the upgrade instructions avoids computation of upgrade instructions for each hop in the fragment chain.

As described above, during operations, the object is upgraded and the corresponding upgrade instruction are memorized and compacted and stored in an upgrade database. An example of how an object is upgraded by referencing fragments is described below in further detail.

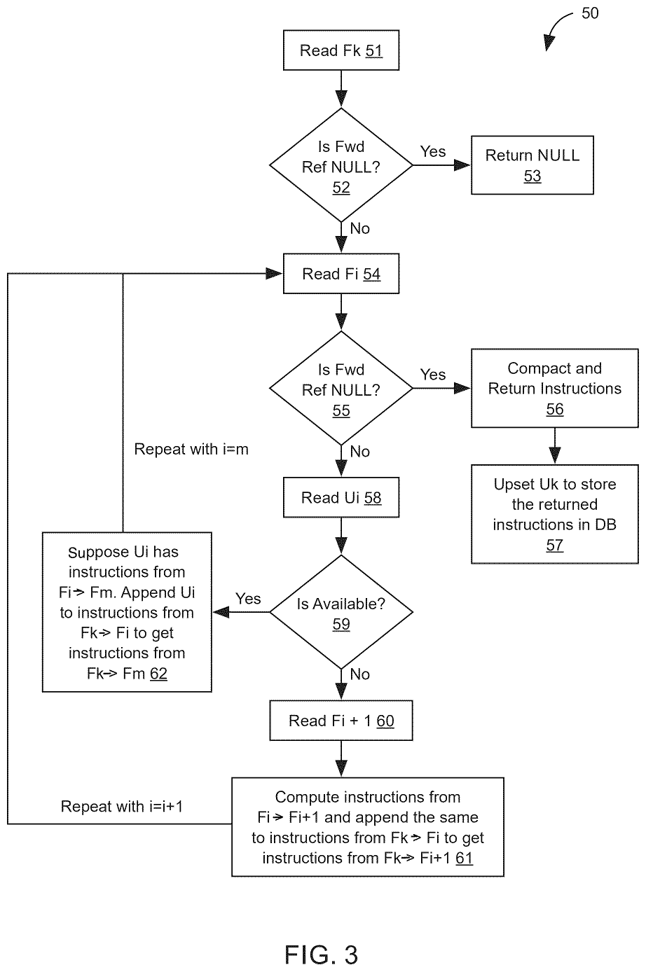

FIG. 3 is a flow chart depiction an operation where fragments are read and a corresponding object is updated. It may be noted that before performing the operation a one-time migration is run which starts from a pen-ultimate fragment and persists instructions for every fragment in the fragment chain to the latest known fragment in a single pass. In addition, these instructions are enhanced over time with every read/write operation on the object. Thus, in the steady state, upgrading a fragment to the latest version will have very few fragment hops. The process is described in further detail below.

At step 51, an initial fragment is read. In this example, the fragment is ‘Fk’. At step 52, the forward reference is checked for a ‘NULL value. If yes, then the process ends at step 53. If the forward reference is pointing to another fragment, ‘Fi’ as shown in the figure, then ‘Fi’ is read at step 54. Again, at step 55, the forward reference in fragment ‘Fi’ is checked for a ‘NULL’ value. If yes, then the corresponding upgrade instructions are compacted as shown in step 56. Further, at step 57, the upgraded instructions are stored in upgrade database.

However, if the forward reference in fragment ‘Fi’ is not ‘NULL’ at step 55, the process proceeds to step 58 to read upgrade instructions (‘Ui’). If upgrade instructions for ‘Fi’ are not available at step 59, the next fragment is read, i.e. ‘Fi+1’, at step 60. At step 61, instructions are computed for ‘Fi to ‘Fi+1’ and these instructions are appended to the upgrade instructions from ‘Fk’ to ‘Fi’. This gives us the instructions from ‘Fk’to ‘Fi+1’. Step 54 is repeated with ‘i=i+1’.

However, if upgrade instructions for ‘Fi’ are available at step 59, then the process moves to step 62. Suppose, the upgrade instructions for ‘Fi’ read from the database have instructions for ‘Fi’ to ‘Fm’. The same are appended to the upgrade instructions from ‘Fk’ to ‘Fi’. This provides the instructions from ‘Fk’ to ‘Fm’. Step 54 is repeated with ‘i=m’ where m is an intermediate fragment between ‘Fk’ and ‘Fn’ where ‘Fn’ is the latest fragment.

In one embodiment, fragments are immutable to maintain referential integrity. The number of fragment versions is a monotonically increasing number. Consequently, the amount of computation involved in upgrading an object increases with the increase in the number of fragment versions. Further, it may be noted that a fragment can't be upgraded to the latest version without reading the intermediate versions

As described above, all upgrade instructions are memorized by storing in the upgrade database. Thus, during object reads and writes subsequent operations on objects referencing the fragment are faster. Additionally, by restricting the size of these instructions the operation is faster and more efficient by using limited resources.

Further upgraded instructions are compacted based on the following set of rules to decrease the size of the upgrade instructions. In this embodiment, upgrading an object involves either setting fields with a value or deleting fields. In a further embodiment, the fields are set or deleted based on one or more conditions. The following are the possible instruction types:
SET(v)—Set the value of the concerned field to “v”.
DELETE—Delete the concerned field from the fields map.
SET_CONDITIONAL(v)—Set the value of the concerned field to “v” if the field does not exist in in the object.
DELETE_CONDITIONAL(allowed values)—Delete the concerned field from the fields map if its value isn't one of the allowed values. In one embodiment, this is a special case which occurs when the allowed values of an enum field are modified in a subsequent fragment version, wherein the contents of an enum field are restricted by an allowed values set.

For any sequence of instructions pertaining to a particular field, the following rules are applied. SET/DELETE instructions render all instructions before them redundant. Similarly, a sequence of instructions having at least one SET/DELETE instruction can be compacted into a single SET/DELETE instruction. An example is illustrated below:
SET(a),SET(b)->SET(b)
SET(a),DELETE->DELETE
SET(a),SET_CONDITIONAL(v)->SET(a)
SET(a),DELETE_CONDITIONAL(allowedvalues)->SET(a)ifa∈allowed values, else DELETE
DELETE,SET(a)->SET(a)
DELETE,DELETE->DELETE
DELETE,SET_CONDITIONAL(v)->SET(v)
DELETE,DELETE_CONDITIONAL(allowedvalues)->DELETE

Further, all adjacent SET_CONDITIONAL instructions are merged into a single SET_CONDITIONAL with the value as the value of the first instruction. Similarly, all adjacent DELETE_CONDITIONAL instructions are merged into a single DELETE_CONDITIONAL instruction with the allowed values as the intersection of allowed values of both instructions. In a specific embodiment, if this intersection is a NULL set, both instructions are replaced by a single DELETE instruction.

Further, if two identical SET_CONDITIONAL instructions are separated only by DELETE_CONDITIONAL instructions, the first SET_CONDITIONAL instruction is dropped. Similarly, if two DELETE_CONDITIONAL instructions are separated only by SET_CONDITIONAL instructions, the first DELETE_CONDITIONAL instruction is dropped.

For example, consider the following sequence of instructions:
1.SET_CONDITIONAL(a)
2.SET_CONDITIONAL(b)
3. DELETE_CONDITIONAL([a, b, c])
4. DELETE_CONDITIONAL([d, e, f])
5. SET_CONDITIONAL(b)

After applying the above-described rules for compaction, the compacted instruction will simply read SET(b).

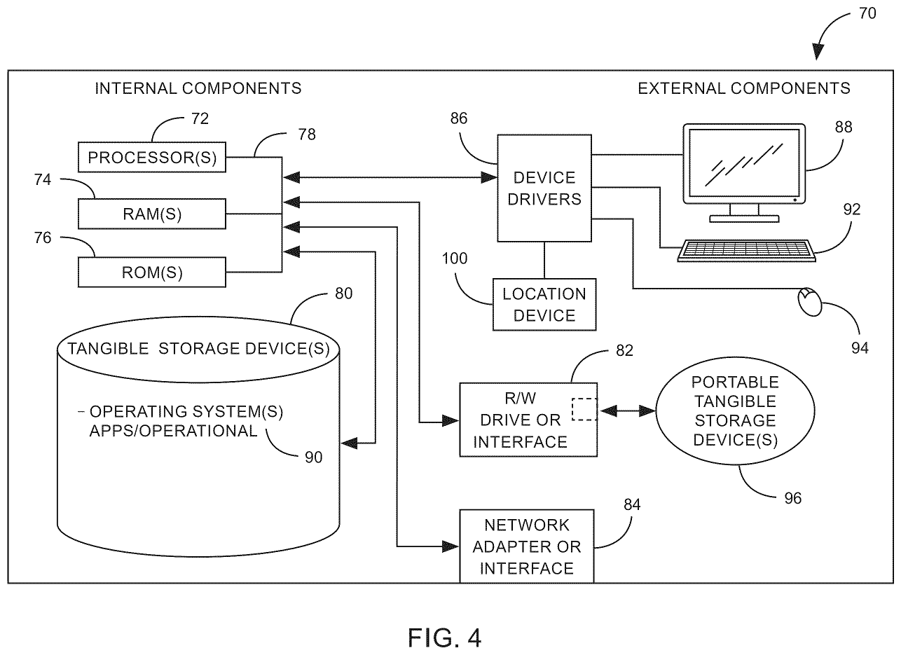

The method to update objects described herein is implemented using a computing device such as computing device 70 is described below in FIG. 4. The computing device 70 includes one or more processor(s) 72, one or more computer-readable RAMs 74 and one or more computer-readable ROMs 76 on one or more buses 78. Further, computing device 70 includes a tangible storage device 80 that includes operating system 90. The operating systems 90 are executed by the one or more processor(s) 72 via one or more respective RAMs 74 (which typically include cache memory). The execution of the operating systems 90 by the one or more processor(s) configures the one or more processor(s) as a special purpose processor configured to carry out upgrade operations described above.

Examples of the tangible storage device include semiconductor storage devices such as ROM, EPROM, flash memory or any other computer-readable tangible storage device that may store a computer program and digital information.

Computing device 70 also includes a R/W drive or interface 82 to read from and write to one or more portable computer-readable tangible storage devices 96 such as a CD-ROM, DVD, memory stick or semiconductor storage device. Further, network adapters or interfaces 84 such as a TCP/IP adapter cards, wireless Wi-Fi interface cards, or 3G or 4G wireless interface cards or other wired or wireless communication links are also included in computing device.

Computing device 70 further includes device drivers 86 to interface with input and output devices. The input and output devices may include a computer display monitor 88, a keyboard 92, a keypad, a touch screen, a computer mouse 94, and/or some other suitable input device.

In this description, including the definitions mentioned earlier, the term ‘module’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware. The term code, as used above, may include software, firmware, and/or microcode, and may refer to programs, routines, functions, classes, data structures, and/or objects.

Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above. Shared memory hardware encompasses a single memory device that stores some or all code from multiple modules. Group memory hardware encompasses a memory device that, in combination with other memory devices, stores some or all code from one or more modules.

In some embodiments, the module may include one or more interface circuits. In some examples, the interface circuits may include wired or wireless interfaces that are connected to a local area network (LAN), the Internet, a wide area network (WAN), or combinations thereof. The functionality of any given module of the present description may be distributed among multiple modules that are connected via interface circuits. For example, multiple modules may allow load balancing. In a further example, a server (also known as remote, or cloud) module may accomplish some functionality on behalf of a client module.

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

The aforementioned description is merely illustrative in nature and is in no way intended to limit the disclosure, its application, or uses. The broad teachings of the disclosure may be implemented in a variety of forms. Therefore, while this disclosure includes particular examples, the true scope of the disclosure should not be so limited since other modifications will become apparent upon a study of the drawings, the specification. It should be understood that one or more steps within a method may be executed in different order (or concurrently) without altering the principles of the present disclosure. Further, although each of the example embodiments is described above as having certain features, any one or more of those features described with respect to any example embodiment of the disclosure may be implemented in and/or combined with features of any of the other embodiments, even if that combination is not explicitly described. In other words, the described example embodiments are not mutually exclusive, and permutations of one or more example embodiments with one another remain within the scope of this disclosure.

The example embodiment or each example embodiment should not be understood as a limiting/restrictive of inventive concepts. Rather, numerous variations and modifications are possible in the context of the present disclosure, in particular those variants and combinations which may be inferred by the person skilled in the art with regard to achieving the object for example by combination or modification of individual features or elements or method steps that are described in connection with the general or specific part of the description and/or the drawings, and, by way of combinable features, lead to a new subject matter or to new method steps or sequences of method steps, including insofar as they concern production, testing and operating methods. Further, elements and/or features of different example embodiments may be combined with each other and/or substituted for each other within the scope of this disclosure.

Still further, any one of the above-described and other example features of example embodiments may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Further, at least one example embodiment relates to a non-transitory computer-readable storage medium comprising electronically readable control information (e.g., computer-readable instructions) stored thereon, configured such that when the storage medium is used in a controller of a magnetic resonance device, at least one example embodiment of the method is carried out.

Even further, any of the aforementioned methods may be embodied in the form of a program. The program may be stored on a non-transitory computer readable medium, such that when run on a computer device (e.g., a processor), cause the computer-device to perform any one of the aforementioned methods. Thus, the non-transitory, tangible computer readable medium is adapted to store information and is adapted to interact with a data processing facility or computer device to execute the program of any of the above-mentioned embodiments and/or to perform the method of any of the above-mentioned embodiments.

The computer readable medium or storage medium may be a built-in medium installed inside a computer device main body or a removable medium arranged so that it may be separated from the computer device main body. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The apparatuses and methods described in this application may be partially or fully implemented by a special purpose computer created by configuring a general-purpose computer to execute one or more particular functions embodied in computer programs. The functional blocks and flowchart elements described above serve as software specifications, which may be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

While only certain features of several embodiments have been illustrated, and described herein, many modifications and changes will occur to those skilled in the art. It is, therefore, to be understood that the appended claims are intended to cover all such modifications and changes as fall within the true spirit of inventive concepts.

What is claimed is:

1. A computer implemented method for upgrading objects, the method comprising:
creating one or more fragments using an application programming interface (API); wherein each fragment comprises a fragment identifier, one or more field definitions, a forward reference and a backward reference;
generating an object by referencing the one or more fragments and storing a value associated with each field;
during operations, upgrading the object upon encountering modified fragments; wherein upgrading comprises updating the object from one fragment to a latest fragment; and
memorizing the upgrade instructions in an upgrade database.

2. The computer implemented method of claim 1, wherein the one or more fragments together form a fragment chain, wherein the one or more fragments reference with the forward and backward reference.

3. The computer implemented method of claim 1, wherein the upgrading the object further comprises:
identifying the one or more fragments associated with the object;
reading each fragment until a latest fragment is determined; and
upgrading the object based on the latest fragment; wherein forward reference field of the latest fragment is “NULL”.

4. The computer implemented method of claim 1, further comprising enabling a user to modify the one or more fragments by adding or deleting fields.

5. The computer implemented method of claim 1, wherein the upgrading the object further comprises reading the forward reference field of an initial fragment to determine a presence of a subsequent fragment.

6. The computer implemented method of claim 5, further comprising, upgrading the object with upgrade instructions associated with the initial fragment in the presence of the subsequent fragment.

7. The computer implemented method of claim 6, further comprising, reading the subsequent fragment and upgrading the object in the absence of upgrade instructions associated with the fragment.

8. The computer implemented method of claim 7, wherein the one or more fragments are read until the latest fragment is identified.

9. The computer implemented method of claim 1, further comprising compacting upgrade instructions corresponding to the upgraded object by deleting redundant instructions.

10. The computer implemented method of claim 9, further comprising compacting the upgrade instructions corresponding to the last fragment and storing the upgrade instructions in the database.

11. The computer implemented method of claim 10, wherein the compacting further comprises removing copies of more than one “set or delete” instructions and retaining a single “set or delete” instruction.

12. The computer implemented method of claim 9, wherein the compacting further comprises merging adjacent conditional instructions into a single conditional instruction.

13. A computer processing system comprises a processing unit; a communications interface; and a non-transitory computer-readable storage medium to store instructions, wherein the processing unit execute the stored instructions to:
create one or more fragments using an application programming interface (API); wherein each fragment comprises a fragment identifier, one or more fields, a forward reference field and a backward reference field and wherein the one or more fragments together form a fragment chain, wherein the one or more fragments reference with the forward and backward reference;
generate an object by referencing the one or more fragments and storing a value associated with each field;
during operations, upgrade the object upon encountering modified fragments; wherein upgrading comprises updating the object from one fragment to a latest fragment; and
memorize the upgrade instructions in a upgrade database.

14. The computer processing system of claim 13, wherein processing unit is configured to upgrade the object by identifying the one or more fragments associated with the object, reading each fragment to determine a latest fragment and upgrading the object based on the latest fragment; wherein forward reference field of the latest fragment is “NULL”.

15. The computer processing system of claim 13, wherein processing unit is configured to enable a user to modify the one or more fragments by adding or deleting fields.

16. The computer processing system of claim 13, wherein processing unit is configured to upgrade the object by reading the forward reference field of an initial fragment to determine a presence of a subsequent fragment; and upgrading the object with upgrade instructions associated with the initial fragment in the absence of the subsequent fragment.

17. The computer processing system of claim 16, wherein processing unit is, upon identification of a subsequent fragment, configured to upgrade the object when with upgrade instructions associated with the subsequent fragment.

18. The computer processing system of claim 16, wherein processing unit is further configured to compact upgrade instructions corresponding to the upgraded object by deleting redundant instructions and storing the upgrade instructions in the upgrade instructions in the database.

19. A computer-readable medium comprising computer executable instructions that when executed by a processor of a computer, allows the processor to perform a method comprising:
creating one or more fragments using an application programming interface (API); wherein each fragment comprises a fragment identifier, one or more fields, a forward reference field and a backward reference field and wherein the one or more fragments together form a fragment chain, wherein the one or more fragments reference with the forward and backward reference;
generating an object by referencing the one or more fragments and storing a value associated with each field;
during operations, upgrading the object upon encountering modified fragments; wherein upgrading comprises updating the object from one fragment to a latest fragment; and
memorizing the upgrade instructions in a upgrade database.

20. A computer-readable medium of claim 19, wherein the upgrading the object further comprises:
identifying the one or more fragments associated with the object;
reading each fragment to determine a latest fragment; and
upgrading the object based on the latest fragment; wherein forward reference field of the latest fragment is “NULL”.

21. The computer-readable medium of claim 20, wherein the upgrading the object further comprises reading the forward reference field of an initial fragment to determine a presence of a subsequent fragment and upgrading the object with upgrade instructions associated with the initial fragment in the absence of the subsequent fragment.

22. The computer-readable medium of claim 21, further comprising, in the presence of a subsequent fragment, reading the subsequent fragment and upgrading the object with upgrade instructions associated with the subsequent fragment; wherein the one or more fragments are read until the latest fragment is identified.

23. The computer-readable medium of claim 20, further comprising compacting upgrade instructions corresponding to the upgraded object by deleting redundant instructions.

24. The computer-readable medium of claim 23, further comprising compacting the upgrade instructions corresponding to the latest fragment and storing the upgrade instructions in the database.
